(19) United States
(12) Patent Application Publication
(10) Pub. No.: US 2022/0337708 A1
(43) Pub. Date: Oct. 20, 2022

(54) OPERATION MODE SETTING APPARATUS

(71) Applicant: KYOCERA Document Solutions Inc., Osaka (JP)

(72) Inventor: Masakazu YAMAMOTO, Osaka-shi (JP)

(73) Assignee: KYOCERA Document Solutions Inc., Osaka (JP)

(21) Appl. No.: 17/724,079

(22) Filed: Apr. 19, 2022

(30) Foreign Application Priority Data
Apr. 20, 2021 (JP) 2021-071119

(51) Int. Cl. H04N 1/00

(52) U.S. Cl. CPC H04N 1/00084; H04N 1/00063; H04N 1/00037; H04N 1/0009; H04N 1/00029; H04N 1/00244

(57) ABSTRACT

An operation mode setting apparatus includes: a log information acquiring section which acquires log information of a target device capable of switching a normal mode operation that is performable in a normal mode and a maintenance mode operation that is performable in a maintenance mode; an operation history information acquiring section which acquires maintenance mode operation history information indicating an operation history of the target device in the maintenance mode; a specific operation extracting section which extracts a maintenance mode operation which is to be performed in the maintenance mode under a specific condition in the log information as a specific operation based on the log information acquired by the log information acquiring section and the maintenance mode operation history information acquired by the operation history information acquiring section; and an operation mode changing section which changes the specific operation from a maintenance mode operation to a normal mode operation.

### INCORPORATION BY REFERENCE

The present application claims priority under 35 U.S.C. § 119 to Japanese Patent Application No. 2021-071119, filed on Apr. 20, 2021. The contents of this application are incorporated herein by reference in their entirety.

### BACKGROUND

The present disclosure relates to an operation mode setting apparatus.

Precision machines such as multifunction peripherals are set up with an operation mode which can be used by an ordinary user and an operation mode which cannot be used by an ordinary user. For example, an operation mode which can be used by an ordinary user is also called a normal mode, and an operation mode which cannot be used by an ordinary user is also called a maintenance mode.

In general, a specially skilled service person replaces or repairs certain parts of a multifunction peripheral in a state in which the operation mode is shifted to the maintenance mode. When the service person shifts the operation mode of an image forming apparatus to the maintenance mode, log data of events detected in the maintenance mode is generated and sent to an external storage device and a maintenance report is received from the external storage device.

### SUMMARY

An operation mode setting apparatus according to an aspect of the present disclosure includes: a log information acquiring section which acquires log information of a target device which is capable of switching a normal mode operation that is performable in a normal mode and a maintenance mode operation that is performable in a maintenance mode; an operation history information acquiring section which acquires maintenance mode operation history information indicating an operation history of the target device in the maintenance mode; a specific operation extracting section which extracts a maintenance mode operation which is to be performed in the maintenance mode under a specific condition in the log information as a specific operation based on the log information acquired by the log information acquiring section and the maintenance mode operation history information acquired by the operation history information acquiring section; and an operation mode changing section which changes the specific operation from the maintenance mode operation to the normal mode operation.

### BRIEF DESCRIPTION OF THE DRAWINGS

FIG. 1 is a block diagram illustrating an image forming apparatus according to an embodiment.

FIG. 2 is a flowchart depicting an operation flow of the image forming apparatus of the present embodiment.

FIG. 3A is a table illustrating C-call occurrence history information as log information of the image forming apparatus of the present embodiment.

FIG. 3B is a table illustrating maintenance mode operation history information.

FIG. 3C is a table illustrating an example of maintenance mode operations.

FIG. 3D is a table illustrating an example of a display for setting a specific operation which has been changed to a normal mode operation.

FIG. 4A is a table illustrating sensor-detected temperature information as log information of the image forming apparatus of the present embodiment.

FIG. 4B is a table illustrating sensor-detected humidity information as log information of the image forming apparatus of the present embodiment.

FIG. 4C is a table illustrating maintenance mode operation history information.

FIG. 5A is a table illustrating an example of maintenance mode operations.

FIG. 5B is a table illustrating an example of a display for setting a specific operation which has been changed to a normal mode operation.

FIG. 5C is a table illustrating supplemental information which supplements FIG. 5B.

FIG. 6 is a schematic illustration of an image forming system including the image forming apparatus of the present embodiment.

### DETAILED DESCRIPTION

The following describes an operation mode setting apparatus according to an embodiment of the present disclosure with reference to the accompanying drawings. Note that elements which are the same or equivalent are labeled with the same reference signs in the drawings and description thereof is not repeated.

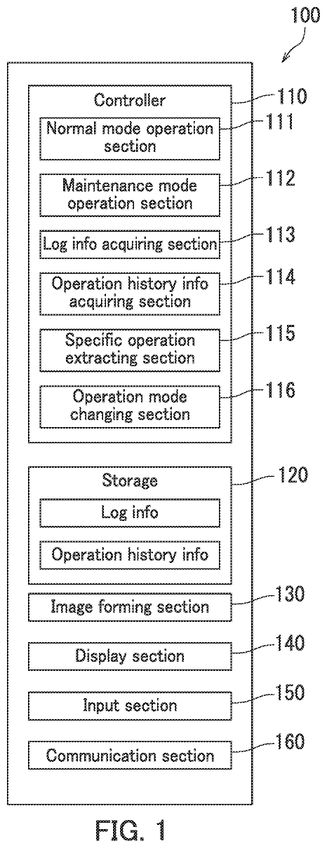

First, the operation mode setting apparatus in the embodiment of the present disclosure is described with reference to FIG. 1. FIG. 1 is a block diagram illustrating an image forming apparatus 100 of the present embodiment. The image forming apparatus 100 is an example of the operation mode setting apparatus.

The image forming apparatus 100 forms an image on a sheet. Examples of the image forming apparatus 100 include a printer, a copier, and a multifunction peripheral. The image forming apparatus 100 may also have a facsimile machine function. Here, the image forming apparatus 100 is an electrographic image forming apparatus. However, the image forming apparatus 100 may be an inkjet image forming apparatus.

The image forming apparatus 100 is switched between a normal mode and a maintenance mode and operated. In the normal mode, the image forming apparatus 100 can be operated normally. In the normal mode, an ordinary user operates the image forming apparatus 100.

In the maintenance mode, the image forming apparatus 100 can perform maintenance mode operations. Typically, in the maintenance mode, a service person, the manufacturer of the image forming apparatus 100, or a person with special knowledge or training in the operation of the image forming apparatus 100 operates the image forming apparatus 100. An operator in the maintenance mode is more restricted than an operator in the normal mode. When the image forming apparatus 100 has malfunctioned or when a component other than a general-purpose component of the image forming apparatus 100 is replaced or repaired, the image forming apparatus 100 is operated in the maintenance mode.

The image forming apparatus 100 includes a controller 110, storage 120, an image forming section 130, a display section 140, and an input section 150. The controller 110 controls the storage 120, the display section 140, and the input section 150.

The controller 110 includes an arithmetic element. The arithmetic element includes a processor. In one example, the processor includes a central processing unit (CPU).

The storage 120 stores data and a computer program. The storage 120 includes a storage element. The storage 120 includes a main storage element such as semiconductor memory and an auxiliary storage element such as either or both of semiconductor memory and a hard disk drive. The storage 120 may include removable media. The processor of the controller 110 executes the computer program stored in the storage element of the storage 120 to control each component of the image forming apparatus 100.

For example, the computer program can be stored in a non-transitory computer-readable recording medium. The non-transitory computer-readable recording medium includes read-only memory (ROM), random-access memory (RAM), compact disc read-only memory (CD-ROM), magnetic tape, a magnetic disk, or an optical data storage device.

The storage 120 stores operations which can be performed by the controller 110. Typically, the storage 120 stores operations which can be performed in the normal mode separately from operations which can be performed in the maintenance mode. The storage 120 may store operations which can be performed in the normal mode as public information which can be accessed externally. Furthermore, the storage 120 may store operations which can be performed in the maintenance mode as private information which cannot be accessed externally. Operation information which can be performed in the normal mode and be released to third parties may be released to an ordinary user of the image forming apparatus 100 or to any device which can communicate with the image forming apparatus 100.

The storage 120 stores log information of the image forming apparatus 100. For example, the storage 120 stores operations or actions performed by the image forming apparatus 100 in the past as log information. In one example, the storage 120 stores a history of anomalies which have occurred in the image forming apparatus 100 in the past (anomaly occurrence history) as log information. In addition, the storage 120 stores effects detected in the image forming apparatus 100 in the past as log information. Note that the storage 120 may store log information generated by another image forming apparatus of the same type as the image forming apparatus 100.

The storage 120 also stores operation history information of the image forming apparatus 100. In one example, the storage 120 stores operation history information indicating a history of operations performed by the image forming apparatus 100 in the past. For example, the storage 120 stores maintenance mode operation history information indicating a history of maintenance mode operations performed by the image forming apparatus 100 in the maintenance mode in the past. Note that the storage 120 may store normal mode operation history information indicating a history of normal mode operations performed by the image forming apparatus 100 in the normal mode in the past. Alternatively, the storage 120 may store operation history information generated by another image forming apparatus of the same type as the image forming apparatus 100.

The image forming section 130 forms an image on a sheet according to image data. The image forming section 130 may use toner to form an image on a sheet. Alternatively, the image forming section 130 may use ink to form an image on a sheet.

The display section 140 displays the image according to the image data. As such, the operator of the image forming apparatus 100 can view the image data before the image forming section 130 forms the image on a sheet.

The display section 140 includes a liquid-crystal display (LCD), an organic electroluminescent (EL) display, or a plasma display.

Instructions of the operator are input to the input section 150. The operator can operate a screen displayed by the display section 140 using the input section 150. A user can operate a screen displayed by the display section 140 using the input section 150.

The input section 150 includes buttons or a keyboard. Alternatively, the input section 150 may include a touch sensor. The display section 140 and the input section 150 may both be integrated into a touch panel.

The image forming apparatus 100 may further include a communication section 160. The communication section 160 communicates with an external device. For example, the communication section 160 may receive image data from an external device. The communication section 160 may also receive either or both of log information and operation history information of an image forming apparatus of the same type as the image forming apparatus 100 from an external device. Alternatively, the communication section 160 may send either or both of the log information and the operation history information of the image forming apparatus 100 to an external server for storage on the external server instead of the storage 120 and receive either or both of log information and operation history information of the image forming apparatus 100 from the external server as necessary.

By executing the computer program, the controller 110 functions as a normal mode operation section 111, a maintenance mode operation section 112, a log information acquiring section 113, an operation history information acquiring section 114, a specific operation extracting section 115, and an operation mode changing section 116.

The normal mode operation section 111 operates in the normal mode. When an operation set as an normal mode operation is input from the input section 150 in the normal mode, the normal mode operation section 111 performs the operation according to the input.

The maintenance mode operation section 112 operates in the maintenance mode. When an operation set as an operation of the maintenance mode is input from the input section 150 in the maintenance mode, the maintenance mode operation section 112 performs the operation according to the input.

The log information acquiring section 113 acquires log information of the image forming apparatus 100. Typically, the storage 120 stores log information of operations performed by the image forming apparatus 100 in the past, and the log information acquiring section 113 acquires the log information from the storage 120.

The operation history information acquiring section 114 acquires the operation history information of operations performed by the image forming apparatus 100 in the maintenance mode. Typically, the storage 120 stores operation history information of operations performed by the image forming apparatus 100 in the maintenance mode in the past, and the operation history information acquiring section 114 acquires the maintenance mode operation history information from the storage 120.

The specific operation extracting section 115 extracts a maintenance mode operation which is to be performed under a specific condition in the log information as a specific operation from the maintenance mode operation history information based on the log information acquired by the log information acquiring section 113 and the maintenance mode operation history information acquired by the operation history information acquiring section 114.

The operation mode changing section 116 changes the specific operation extracted by the specific operation extracting section 115 from a maintenance mode operation to a normal mode operation.

According to the image forming apparatus 100 of the present embodiment, a maintenance mode operation set to the maintenance mode can be changed to a normal mode operation.

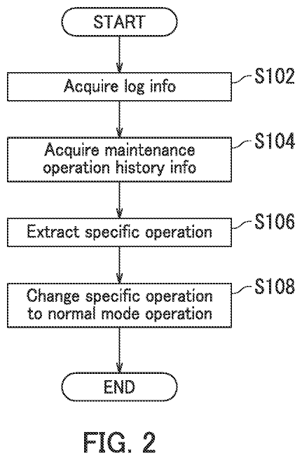

Next, the image forming apparatus 100 of the present embodiment is described with reference to FIGS. 1 and 2. FIG. 2 is a flowchart depicting the operation of the image forming apparatus 100 of the present embodiment.

In Step S102 as illustrated in FIG. 2, log information of the image forming apparatus 100 is acquired. The log information acquiring section 113 acquires log information of operations performed by the image forming apparatus 100 in the past from the storage 120.

In Step S104, maintenance mode operation history information is acquired. The operation history information acquiring section 114 acquires the maintenance mode operation history information of operations performed by the image forming apparatus 100 in the maintenance mode.

In Step S106, a maintenance mode operation which is to be performed under a specific condition in the log information is extracted as a specific operation. The specific operation extracting section 115 extracts the maintenance mode operation which is to be performed under the specific condition in the log information as a specific operation based on the log information acquired by the log information acquiring section 113 and the maintenance mode operation history information acquired by the operation history information acquiring section 114.

In Step S108, the operation mode changing section 116 changes the extracted specific operation from a maintenance mode operation to a normal mode operation.

In the above manner, a maintenance mode operation can be changed to a normal mode operation according to the present embodiment.

For example, the image forming apparatus 100 may extract a specific operation based on anomaly history information and maintenance mode operation history information as log information.

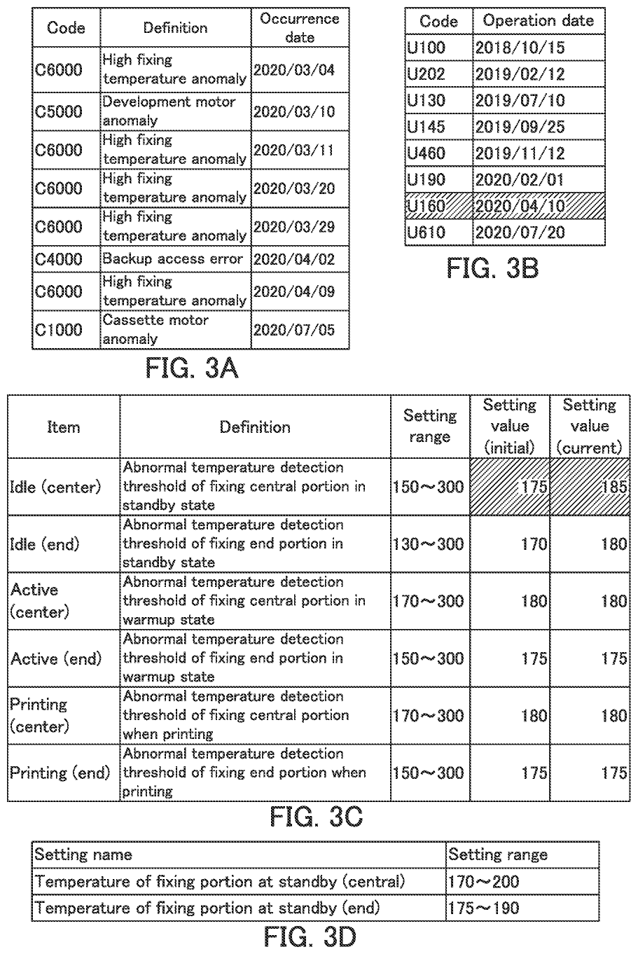

Next, the extraction of a specific operation and the mode change of the specific operation in the image forming apparatus 100 of the present embodiment is specifically described with reference to FIGS. 1 to 3. FIG. 3A is a table illustrating C-call occurrence history information stored in the storage 120 of the image forming apparatus 100. FIG. 3B is a table illustrating maintenance mode operation history information stored in the storage 120 of the image forming apparatus 100.

As illustrated in FIG. 3A, the C-call occurrence history information has code numbers indicating the types of C-calls which have occurred in the image forming apparatus 100, definitions corresponding to the code numbers, and occurrence dates. For example, a high fixing temperature anomaly occurring on 4 Mar. 2020 and a development motor anomaly occurring on 10 Mar. 2020 are listed in the C-call occurrence history. Here, a high fixing temperature anomaly is indicated by the code number C6000 and a development motor anomaly is indicated by the code number C5000.

In this C-call occurrence history information, high fixing temperature anomalies indicated by the code number C6000 have occurred multiple times. Specifically, a high fixing temperature anomaly has occurred not only on 4 Mar. 2020, but also on 11 Mar. 2020, 20 Mar. 2020, 29 Mar. 2020, and 9 Apr. 2020. From this, it is understood that high fixing temperature anomalies were frequently observed from March to early April 2020. By contrast, a high fixing temperature anomaly has not occurred since 9 Apr. 2020. Note that the C-call occurrence history illustrated in FIG. 3A is an example of anomaly occurrence history log information of the image forming apparatus 100.

In the image forming apparatus 100 of the present embodiment, the log information acquiring section 113 acquires C-call occurrence history information as log information from the storage 120.

As illustrated in FIG. 3B, maintenance mode operation history information indicating a history of operations performed in the maintenance mode is stored in the storage 120. The maintenance mode operation history information has code numbers indicating the types of maintenance mode operations and operation dates on which the maintenance mode operations were performed. For example, performance of a maintenance mode operation indicated by the code number U100 on 15 Oct. 2018 and a maintenance mode operation indicated by the code number U202 on 12 Feb. 2019 is listed in the maintenance mode operation history information.

In the image forming apparatus 100 of the present embodiment, the operation history information acquiring section 114 acquires maintenance mode operation history information from the storage 120. The operation history information acquiring section 114 acquires maintenance mode operation history information indicating a history of maintenance operations performed by the image forming apparatus 100 in the maintenance mode.

Thereafter, the specific operation extracting section 115 extracts a maintenance mode operation which is to be performed under a specific condition in log information as a specific operation from the maintenance mode operation history information based on log information of the past acquired by the log information acquiring section 113 and the maintenance mode operation history information acquired by the operation history information acquiring section 114.

As described above, while high fixing temperature anomalies occurred frequently from March to early April 2020, no high fixing temperature anomalies have occurred since 9 Apr. 2020. As such, the specific operation extracting section 115 extracts the maintenance mode operation performed immediately after 9 Apr. 2020 from the maintenance mode operation history information. Here, the maintenance mode operation extracted by the specific operation extracting section 115 is a maintenance mode operation indicated by the code number U160 which was performed on 10 Apr. 2020. As such, the maintenance mode operation indicated by the code number U160 is extracted as the specific operation.

For example, the specific operation extracting section 115 specifies an anomaly occurring repeatedly within a specific period of time. The specific operation extracting section 115 specifies that high fixing temperature anomalies occurred in March and April 2020. The specific operation extracting section 115 also specifies that high fixing temperature anomalies did not occur in May and June 2020.

Thereafter, the specific operation extracting section 115 specifies a maintenance mode operation performed in the maintenance mode within a comparatively short period of time after the last anomaly occurred in the specific period of time. Specifically, the specific operation extracting section 115 specifies a maintenance mode operation performed in the maintenance mode within one month of 9 Apr. 2020. Here, the specific operation extracting section 115 extracts the maintenance mode operation indicated by the code number U160 as the specific operation from the maintenance mode operation history information.

Thereafter, the operation mode changing section 116 changes the specific operation from a maintenance mode operation to a normal mode operation. Note that when changed to a normal mode operation, the specific operation may be released as public information.

The extraction of a specific operation by the specific operation extracting section 115 and the change of operation mode by the operation mode changing section 116 may be performed by machine learning.

According to the image forming apparatus 100 of the present embodiment, a maintenance mode operation set to the maintenance mode can be changed to the normal mode.

The specific operation extracting section 115 may more specifically specify a maintenance mode operation to be extracted as a specific operation.

FIG. 3C is a table illustrating items, definitions, setting ranges, setting values (initial values), and setting values (current values) which can be set with the code number U160 in the maintenance mode. As illustrated in FIG. 3C, an operation indicated by the code number U160 in the maintenance mode sets a threshold for determining whether or not a fixing temperature is abnormal under various conditions. For example, a threshold of the fixing temperature of a central portion when idle and a threshold of the fixing temperature of an end portion when idle can be set within a predetermined range.

The maintenance mode operation indicated by the code number U160 performed on 10 Apr. 2020 changed the threshold of the fixing temperature of the center portion when idle from 175° C. to 185° C. and the threshold of the fixing temperature of the end portion when idle from 170° C. to 180° C. It is thought that the occurrence of a high fixing temperature anomaly was avoided due to this maintenance mode operation.

As such, the specific operation extracting section 115 extracts the setting of the threshold of the fixing temperature at the idle central portion in a standby state and the setting of the threshold of the fixing temperature of the idle end portion in a standby state as specific operations, and the operation mode changing section 116 changes the setting of respective thresholds of fixing temperatures of a fixing central portion and a fixing end portion in the standby state to ranges near 185° C. and 180° C. from maintenance mode operations to normal mode operations. Note that when changed to normal mode operations, the specific operations may be released as public information.

FIG. 3D is a table illustrating an example of a display for setting specific operations which have been changed to normal mode operations. As illustrated in FIG. 3D, the threshold of the fixing temperature of the fixing central portion in the standby state is displayed such that it can be set within a range of 170° C. to 200° C., and the threshold of the fixing temperature of the fixing end portion in the standby state is displayed such that it can be set within a range of 175° C. to 190° C.

When changing a specific operation from a maintenance mode operation to a normal mode operation, the operation mode changing section 116 may determine whether or not the specific operation is included within a range which can be set in the normal mode and change the specific operation from a maintenance mode operation to a normal mode operation. Through the above, the specific operation which has been changed to a normal mode operation is an operation initially included in the normal mode, and is therefore suitable for use by an ordinary user.

Note that C-call occurrence history information to be transferred to the maintenance mode was described as an example of log information with reference to FIG. 3, but the present embodiment is not limited as such. The log information may be information which is normally stored in the normal mode.

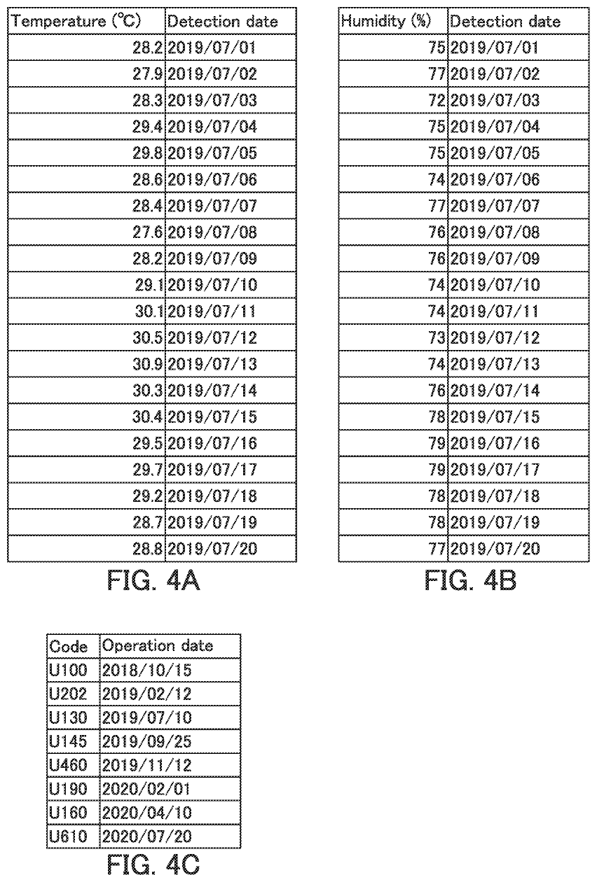

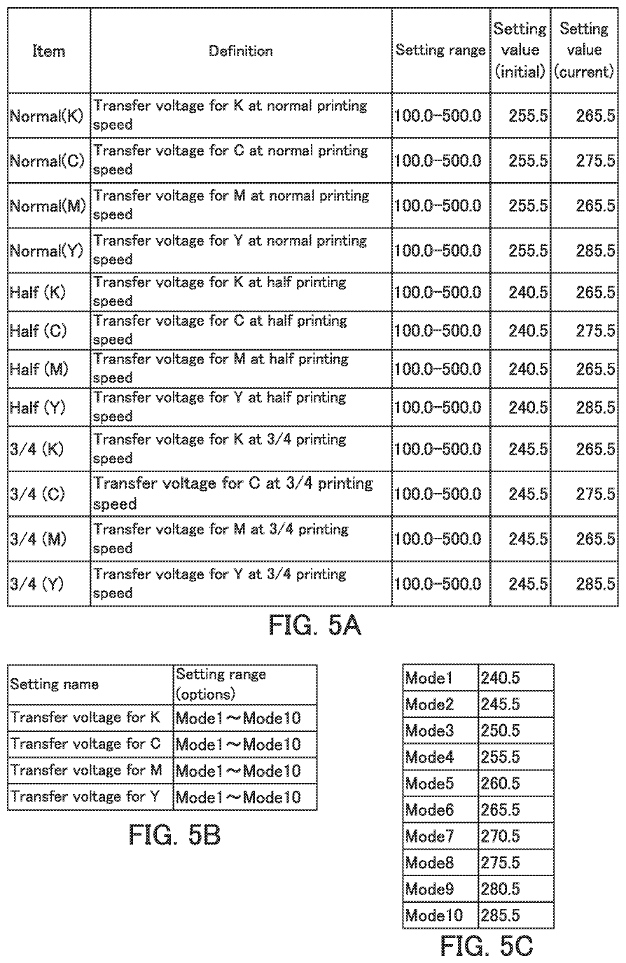

Next, the extraction of a specific maintenance mode operation in the image forming apparatus 100 of the present embodiment is specifically described with reference to FIGS. 1 to 5. FIG. 4A is a table illustrating sensor-detected temperature information as log information of the image forming apparatus 100 of the present embodiment. FIG. 4B is a table illustrating sensor-detected humidity information as log information of the image forming apparatus 100 of the present embodiment. FIG. 4C is a table illustrating maintenance mode operation history information. FIG. 5A is a table illustrating an example of maintenance mode operations.

As illustrated in FIG. 4A, the sensor-detected temperature information has temperatures of the usage environment of the image forming apparatus 100 and dates when the temperatures were detected. For example, a temperature of 28.2° C. detected on 1 Jul. 2019 and a temperature of 27.9° C. detected on 2 Jul. 2019 are listed in the sensor-detected temperature information. The sensor-detected temperature information is an example of detection log information.

As illustrated in FIG. 4B, the sensor-detected humidity information has humidities of the usage environment of the image forming apparatus 100 and dates when the humidities were detected. For example, a humidity of 75% detected on 1 Jul. 2019 and a humidity of 77% detected on 2 Jul. 2019 are listed in the sensor-detected humidity information. The sensor-detected humidity information is an example of detection log information.

As illustrated in FIG. 4C, maintenance mode operation history information indicating a history of operations performed in the maintenance mode is stored in the storage 120. The maintenance mode operation history information has code numbers indicating the types of maintenance mode operations and operation dates on which the maintenance mode operations were performed. The maintenance mode operation history information here is the same as the maintenance mode operation history information illustrated in FIG. 3B.

Here, the guaranteed environment of the image forming apparatus 100 is defined as a temperature of 15° C. to 35° C. and a humidity of 20% to 85%. As such, it is understood from the sensor-detected temperature information and the sensor-detected humidity information illustrated in FIGS. 4A and 4B that the guaranteed environment of the image forming apparatus 100 is comparatively high temperature and high humidity. By contrast, in the maintenance mode operation history information, while a maintenance mode operation indicated by the code number U130 was performed on 10 Jul. 2019, no maintenance mode operation was performed thereafter until 25 Sep. 2019.

As such, the specific operation extracting section 115 extracts the maintenance mode operation indicated by the code number U130 as a specific operation applicable to high temperature and high humidity. In more detail, the specific operation extracting section 115 extracts the operation performed on 10 Jul. 2019 among maintenance mode operations indicated by the code number U130.

FIG. 5A is a table illustrating items, definitions, setting ranges, initial setting values, and setting values which can be set with the code number U130 in the maintenance mode. The operations indicated by the code number U130 in the maintenance mode relate to transfer voltage settings.

As illustrated in FIG. 5A, a transfer voltage can be set under various conditions in an operation indicated by the code number U130 in the maintenance mode. For example, in an operation indicated by the code number U130, transfer voltages can be set for K, C, M, and Y at normal printing speed, and can be set for K, C, M, and Y at half printing speed.

In the maintenance mode operation performed on 10 Jul. 2019, the transfer voltage for K was set to 265.5 V regardless of difference in printing speed. Similarly, the respective transfer voltages for C, M, and Y were set to 275.5 V, 265.5 V, and 285.5 V regardless of difference in printing speed. As such, the specific operation extracting section 115 extracts the constant setting of the respective transfer voltages for K, C, M, and Y regardless of difference in printing speed as a specific operation, and the operation mode changing section 116 changes the constant setting of the respective transfer voltages for K, C, M, and Y from a maintenance mode operation to a normal mode operation. Note that when changed to a normal mode operation, a screen which enables the setting of the transfer voltages for K, C, M, and Y without indicating difference in printing speed may be released as public information.

FIGS. 5B and 5C are tables illustrating the setting of the transfer voltages which can be operated in the normal mode. As illustrated in FIG. 5B, in the normal mode, the transfer voltages for K, C, M, and Y can be changed in the range of Mode 1 to Mode 10. Mode 1 to Mode 10 are all set to a range in which the influence is small even when set by an ordinary user. In fact, as illustrated in FIG. 5C, the actual transfer voltages are determined for each of Mode 1 to Mode 10. The transfer voltages corresponding to Mode 1 to Mode 10 may be displayed as necessary.

When changing a specific operation from a maintenance mode operation to a normal mode operation, the operation mode changing section 116 may determine whether or not the specific operation is included within a settable range in the normal mode and change the specific operation from a maintenance mode operation to a normal mode operation. Through the above, the specific operation which has been changed to a normal mode operation is an operation initially included in the normal mode, and is therefore suitable for use by an ordinary user.

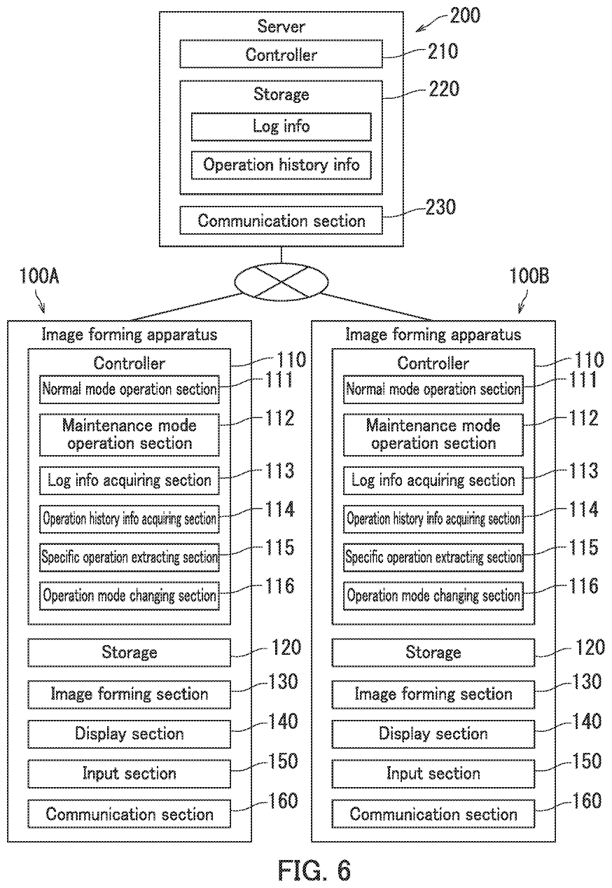

Next, an image forming system 10 according to an embodiment of the present disclosure is described with reference to FIG. 6. FIG. 6 is a schematic illustration of the image forming system 10 of the embodiment of the present disclosure. The image forming system 10 is an example of an operation setting system.

As illustrated in FIG. 6, the image forming system 10 includes a plurality of image forming apparatuses 100 and an information processing apparatus 200. The information processing apparatus 200 is connected to the image forming apparatuses 100 through a network N.

The image forming apparatuses 100 include a first image forming apparatus 100A and a second image forming apparatus 100B. Typically, the first image forming apparatus 100A and the second image forming apparatus 100B are the same type of image forming apparatus. As such, the log information and operation history information of the first image forming apparatus 100A may be used for the second image forming apparatus 100B. The log information and operation history information of the second image forming apparatus 100B may also be used for the first image forming apparatus 100A.

The first image forming apparatus 100A and the second image forming apparatus 100B can communicate with the information processing apparatus 200. The information processing apparatus 200 includes a so-called server. The information processing apparatus 200 includes a controller 210, storage 220, and a communication section 230. The controller 210 controls the storage 220 and the communication section 230.

The controller 210 includes an arithmetic element. The arithmetic element includes a processor. In one example, the processor includes a central processing unit (CPU).

The storage 220 stores data and a computer program. The storage 220 includes a storage element. The storage 220 includes a main storage element such as semiconductor memory and an auxiliary storage element such as either or both of semiconductor memory and a hard disk drive. The storage 220 may include removable media. The processor of the controller 210 executes the computer program stored in the storage element of the storage 220 to control each component of the information processing apparatus 200.

For example, the computer program can be stored in a non-transitory computer-readable recording medium. The non-transitory computer-readable recording medium includes read-only memory (ROM), random-access memory (RAM), compact disc read-only memory (CD-ROM), magnetic tape, a magnetic disk, or an optical data storage device.

The storage 220 stores image data indicating an image. The storage 220 stores log information. The storage 220 may store setting information.

The storage 220 stores log information of the image forming apparatuses 100. For example, the storage 220 stores operations or actions performed by the image forming apparatuses 100 in the past as log information.

The storage 220 also stores operation history information of the image forming apparatuses 100. In one example, the storage 220 stores operation history information indicating a history of operations performed by the image forming apparatuses 100 in the past.

The communication section 230 communicates with external devices. For example, the communication section 230 communicates with the image forming apparatuses 100.

In one example, the communication section 230 receives either or both log information and operation history information of an image forming apparatus 100 from an image forming apparatus 100. The communication section 230 sends either or both of information indicating a specific operation and information for updating a maintenance mode operation and a normal mode operation to a target image forming apparatus 100. As such, the image forming apparatus 100 can extract a specific operation using the log information and the operation history information of another image forming apparatus of the same type and change the specific operation to a normal mode operation.

An image forming apparatus has been described as an example of the operation mode setting apparatus with reference to FIGS. 1 to 6, but the present disclosure is not limited as such. The operation mode setting apparatus can be applied to any apparatus in which different operations are performed in a normal mode and a maintenance mode.

Embodiments of the present disclosure are described above with reference to the accompanying drawings. However, the present disclosure is not limited to the above embodiments and can be implemented in various manners within a scope not departing from the gist thereof. Furthermore, various disclosures can be formed by appropriately combining constituent elements disclosed in the above embodiments. For example, some constituent elements may be removed from the entirety of constituent elements illustrated in the embodiments. In addition, constituent elements may be appropriately combined across different embodiments. The drawings mainly illustrate the various constituent elements schematically for ease of understanding. Aspects such as thickness, length, number, and interval of the constituent elements illustrated in the drawings may differ in practice for convenience of drawing preparation. Aspects such as material, shape, and dimension of the constituent elements illustrated in the above embodiments are one example and not particular limitations. The constituent elements may be variously altered within a scope not substantially departing from the effects of the present disclosure.

What is claimed is:

1. An operation mode setting apparatus comprising:
a log information acquiring section configured to acquire log information of a target device which is capable of switching a normal mode operation that is performable in a normal mode and a maintenance mode operation that is performable in a maintenance mode;
an operation history information acquiring section configured to acquire maintenance mode operation history information indicating an operation history of the target device in the maintenance mode;
a specific operation extracting section configured to extract a maintenance mode operation which is to be performed in the maintenance mode under a specific condition in the log information as a specific operation based on the log information acquired by the log information acquiring section and the maintenance mode operation history information acquired by the operation history information acquiring section; and
an operation mode changing section configured to change the specific operation from the maintenance mode operation to the normal mode operation.

2. The operation mode setting apparatus according to claim 1, wherein
the log information acquiring section acquires anomaly occurrence history log information indicating an anomaly occurrence history in which an anomaly has occurred in the target device in the past, and
when a specific anomaly in the anomaly occurrence history which has occurred more than a prescribed number of times within a prescribed period of time no longer occurs after the prescribed period of time, the specific operation extracting section extracts a maintenance mode operation performed after a last occurrence of the anomaly in the anomaly occurrence history as the specific operation.

3. The operation mode setting apparatus according to claim 1, wherein
the log information acquiring section acquires detection log information indicating detected effects detected in the target device in the past, and
when a specific detected effect in the detected effects has continuously occurred more than a prescribed number of times within a prescribed period of time, the specific operation extracting section extracts a maintenance mode operation performed during the period of time for which the specific detected effect has continuously occurred as the specific operation.

4. The operation mode setting apparatus according to claim 1, further comprising
storage configured to store the normal mode operation as public to external access and store the maintenance mode operation as private to external access, wherein
the operation mode changing section changes the specific operation from private to public to external access by changing the specific operation from the maintenance mode operation to the normal mode operation.
